(19) United States
(12) Patent Application Publication
(10) Pub. No.: US 2006/0191585 A1
(43) Pub. Date: Aug. 31, 2006

(54) Resin tube

(75) Inventor: Naoki Mori, Nishikasugai-gun (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/358,092

(22) Filed: Feb. 22, 2006

(30) Foreign Application Priority Data
Feb. 28, 2005 (JP) 2005-052578

(51) Int. Cl. F16L 11/00

(52) U.S. Cl. 138/121

(57) ABSTRACT

A corrugated tube 30 has corrugated sections 33 in which a plurality of peaks 33a and valleys 33b are alternately formed. The ratio Wb/Wa of the peak longitudinal breadth Wa and the valley longitudinal breadth Wb, with reference to a base line BL established at a position midway in the height direction between the peaks 33a and valleys 33b, is 1.2 to 2.0. The valley 33b floor is formed as a straight portion 33c formed to virtually the same outside diameter along the longitudinal direction of the corrugated tube 30. The corrugated tube 30 stretches less under fluid pressure and has less bending rigidity, improving a better disposition.

This application claims the benefit of and priority from Japanese Application No. 2005-52578 filed Feb. 28, 2005, the content of which is incorporated herein by reference.

### BACKGROUND OF THE INVENTION

1. Field of the Invention

The invention relates to a resin tube having a connecting section and a corrugated section formed alternate parts of peaks and valleys.

2. Description of the Related Art

A conventional resin tube with a corrugated section is described in JP-A 2000-2376, which has been used as a tube employed to supply automobile gas. In addition to basic needs such as fuel pressure resistance and shock absorption, flexibility is required for better disposition in automobile engine compartments. However, when the resin tube is made more flexible, the corrugated section stretches and become considerably bent, meaning into contact with or interfering with peripheral parts. Efforts to overcome such problems by adjusting the thickness of the resin tube to improve the elongation rigidity result in a loss of flexibility and bending difficulties, compromising the disposition. A problem is thus providing such resin tubes with both resistance to stretching caused by fluid pressure and flexibility for better disposition.

### SUMMARY

An advantage of some aspects of the invention is to provide a resin tube which stretches less under fluid pressure, and has less bending rigidity, improving better disposition.

According to an aspect of the invention, the invention is provides with a resin tube comprising a connecting section and a corrugated section formed alternate parts of peaks and valleys. The corrugated section has a straight portion at the valley along a longitudinal direction of the resin tube. The corrugated section is configured to have a rate Wb/Wa that is expressed by 1.2 to 2.0, where Wa denotes a longitudinal breadth of the peak on a base line, and Wb denotes a longitudinal breadth of the valley on the base line, the base line being defined as a line passing a position midway in an outside diameter direction between the peak and valley and drawn along the longitudinal direction.

In the corrugated section of the resin tube in the invention, the ratio Wb/Wa of the peak longitudinal breadth Wa and the valley longitudinal breadth Wb is expressed by 1.2 to 2.0. The peaks have a cut shape with greater longitudinal curvature than the valleys, and the peak portions have less bending rigidity, so that the configuration of the corrugated section has flexibility making them easier to bend, resulting in better disposition. As the valleys are also formed with straight section that is longer in the longitudinal direction than the peaks and that have less curvature, pressure fluid on this part is less likely to result in longitudinal stretching that would cause significant changes in the disposed passageway, preventing interference with other parts. The resin tube thus has both better disposition due to the flexibility, and less interference with other parts because it is less likely to stretch.

In a preferred embodiment of the invention, the resin tube can be used to provide fuel pumped up from a fuel tank into a fuel injection valve of an engine. This resin tube has better resistance to fuel penetration because the valley floor portion of the resin tube is a straight portion with less curvature and have less area in contact with the fuel. Here, the straight portions are shaped with the substantial same outside diameter, with less curvature than the peaks.

In another embodiment, the corrugated sections are formed to substantial same thickness. In this embodiment, production is easier than partially modifying the thickness.

These and other objects, features, aspects, and advantages of the present invention will become more apparent from the following detailed description of the preferred embodiment with the accompanying drawings.

### BRIEF DESCRIPTION OF THE DRAWINGS

FIG. 1 is a schematic structural diagram of an automobile fuel feed system using a resin tube such as in an embodiment of the invention.

FIG. 2 is an external view of the main parts of the resin tube.

FIG. 3 is a cross sectional view of the main parts of the resin tube.

FIG. 4 shows the corrugated section.

FIG. 5 is a graph of the relationship between stretching and length of the corrugated section.

FIG. 6 is a graph of corrugated section the relationship between rigidity and length of the corrugated section.

FIG. 7A, 7B and 7C show comparative examples.

### DESCRIPTION OF THE PREFERRED EMBODIMENTS

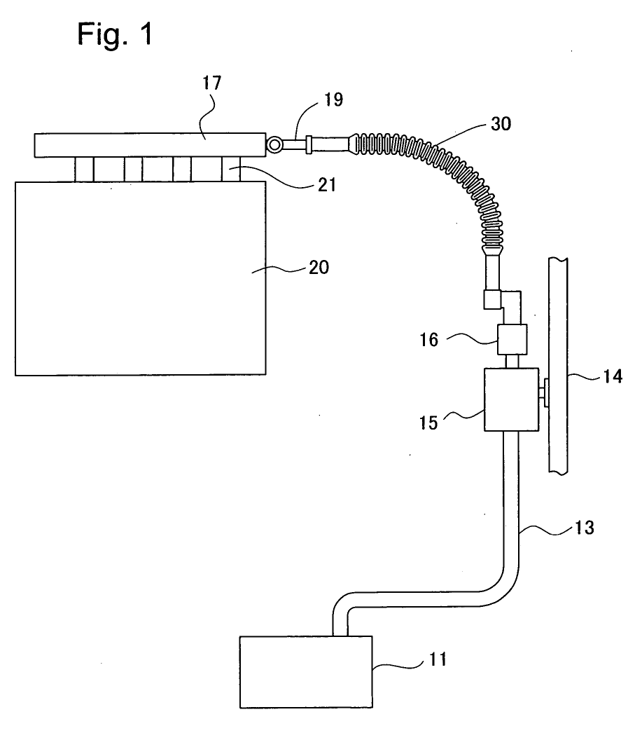

FIG. 1 is a schematic structural diagram of an automobile fuel feed system using a resin tube according to an embodiment of the invention. In FIG. 1, a metal fuel pipe 13 is connected through a fuel pump (not shown) in an automobile fuel tank 11. The fuel pipe 13 is connected to a filter 15 fixed to a dash board 14 behind the engine compartment. The corrugated tube (resin tube) 30 is connected by a quick connector 16 to an outlet of the filter 15. The corrugated tube 30 is drawn into the engine room and connected to a fuel injection valve 21 of an engine 20 by being connected to a cap 19 of a delivery pipe 17. In the fuel feed system, when fuel is pumped up from the fuel tank 11 by the fuel pump, the fuel is pumped under pressure into the corrugated tube 30 through the fuel pipe 13 and filter 15, and is injected into the engine 20 through opening and closing of the fuel injection valve 21. Fuel thus flows through the corrugated tube 30 upon changes in the pressure associated with fuel injection.

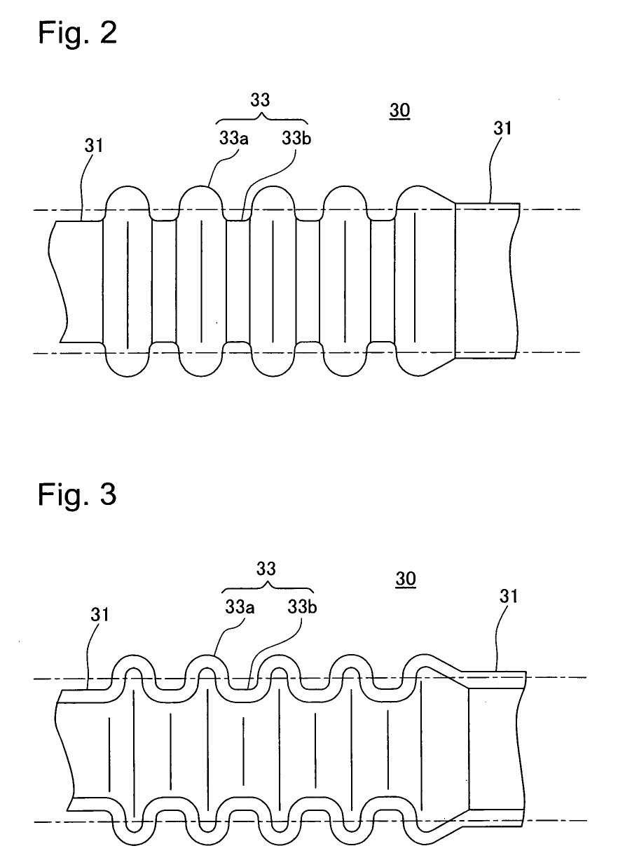

FIG. 2 is an external view of the main parts of the corrugated tube 30, and FIG. 3 is a cross sectional view of the main parts of the corrugated tube 30. The corrugated tube 30 is formed by one or more layers of a resin material, being composed of cylindrical common parts 31, and corrugated parts 33 integrally formed between the common parts 31. Materials that may be used for the corrugated tube 30 include polyamide, fluorine, polyester, polyketone, and polysulfide resins, thermoplastic elastomers, and ethylene-vinyl alcohol copolymers. To increase the flexibility of the corrugated tube 30 itself, 2 to 20 wt % N-n-butyl sulfonamide can be added as a plasticizer when polyamide resins are used, and 1 to 30 wt % paraffin or naphthene oils may be added when thermoplastic elastomers are used.

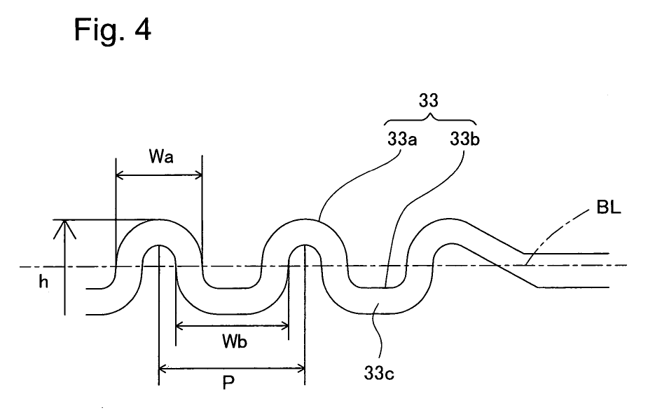

The corrugated parts 33 are structures with alternate parts of peaks 33a and valleys 33b, and are flexible in the longitudinal and bending directions. The kind and hardness of the resin material are set so that the corrugated tube 30 has satisfactory pressure resistance, flow rate, and the like, and the corrugated configuration is determined to meet the required elongation and bend rigidity. That is, the pitches of the peaks 33a and valleys 33b are different from each other. FIG. 4 is an enlarged view of the corrugated part 33. In FIG. 4, a base line BL is established at a position midway in the height h direction between the peaks 33a and valleys 33b, and the ratio Wb/Wa is set to between 1.2 and 2.0, where Wa is the longitudinal breadth of the peaks 33a and Wb is the longitudinal breadth of the valleys 33b on the base line BL. The floor of the valley 33b is a straight portion 33c as a cylindrical floor formed to have cylindrical surface in the longitudinal direction of the corrugated tube 30.

The ratio and configuration are set for the following reasons. When the peaks 33a have a cut shape having greater longitudinal curvature than the valleys, the peaks 33a have less bending rigidity, giving the corrugated tube 30 better flexibility and better disposition. Here, a Wb/Wa ratio of less than 1.2 will fail to provide the elongation and bending rigidity effects described above, whereas more than 2.0 will result in longer valleys 33b, that is, a nearly straight tube, which will have high bending rigidity and will be difficult to bend. The Wb/Wa ratio is more preferably 1.3 to 1.5 in order to enhance such effects.

Because the valleys 33b are formed with a straight portion that is longitudinally longer than the peaks and that has a lower curvature, fluid pressure on this part is less likely to result in longitudinal stretching that would cause the disposed passageway to change very much, so that the corrugated tube 30 is prevented from interfering with other parts.

The corrugated tube 30 thus has both better disposition due to the flexibility, and less interference with other parts because it is less likely to stretch.

Any common method for forming the corrugated parts 33 can be used to produce the corrugated tube 30 of the invention. Various methods can be used, such as injection molding corrugation, continuous extrusion blow molding, and single product blow molding, with no increase in costs.

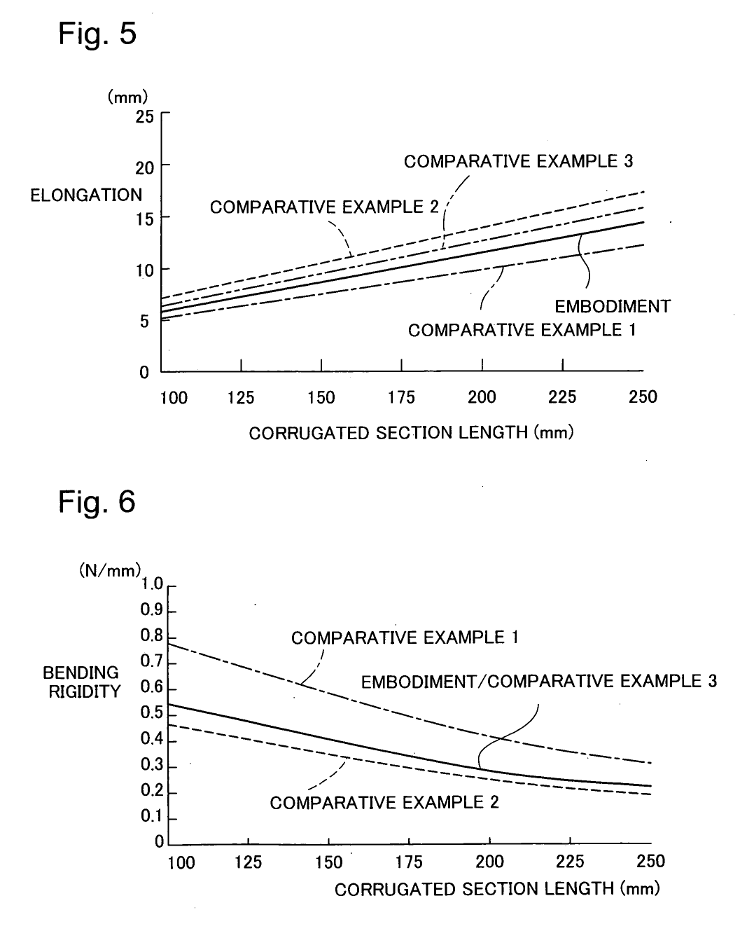

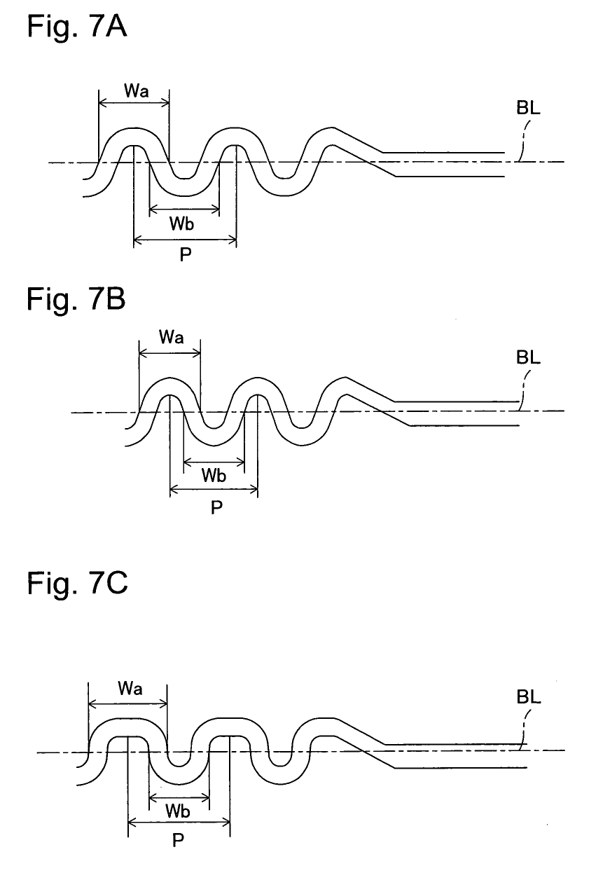

The stretching and bending rigidity of corrugated tubes 30 having such corrugated sections 33 were tested. FIG. 5 is a graph of the relation between stretching in the corrugated sections versus corrugated section length. FIG. 6 is a graph of corrugated section rigidity versus corrugated section length. Here, the embodiments were of the above corrugated tubes 30 in which Wa=2.51 mm and Wb=3.32 mm, where the Wb/Wa=1.32. The peaks 33a had a pitch P=4.19 mm. Comparative Examples 1 through 3 had a structure with different corrugated section shapes, as illustrated in FIG. 7. Comparative Example 1 corresponded to FIG. 7A, in which Wa=2.67 mm and Wb=2.83 mm, where Wb/Wa=1.06 and P=4.19. 7. Comparative Example 2 corresponded to FIG. 7B, in which Wa=2.5 mm and Wb=2.68 mm, where Wb/Wa=1.07 and P=3.56, and a greater number of peaks had virtually the same shape and a narrow pitch P. Comparative Example 3 corresponded to FIG. 7C, in which Wa=3.2 mm and Wb=2.69 mm, where Wb/Wa=0.86 and P=4.19, the peaks and valleys being shaped the opposite of the embodiment of the invention.

The material used in the embodiment and Comparative Examples 1 through 3 was nylon (PA11) 310 mm long and 0.6 mm thick, containing 14 wt % plasticizer (N-n-butyl sulfonamide).

FIG. 5 shows that the corrugated sections in the embodiment of the invention stretched less than Comparative Examples 2 and 3, resulting in less interference. This was because the straight parts limited stretching in the shape of the valleys in the corrugated sections of the embodiment more than the Comparative Examples 2 and 3. The corrugated parts of the embodiment stretched more than in Comparative Example 1, but the bending rigidity was also lower, as illustrated in FIG. 6, providing better disposition. When the corrugated parts are bent, the modulus of elasticity generally increases exponentially, but in the embodiment of the invention, less bending rigidity could be achieved because the peak breadth Wa was narrower and the curvature was greater than in Comparative Example 1, that is, the modules of elasticity was lower.

The area in the embodiment was also lower than in Comparative Examples 1 through 3. This means that there is less area in contact with the fuel flowing through the corrugated tube 30, thus resulting in better resistance to fuel penetration.

The invention is not limited to the above embodiment and can be implemented in a variety of embodiments without departing from the spirit thereof The following variants are possible, for example.

In the embodiment above, the valleys have a straight shape of virtually the same diameter, but the shapes may have slightly different curvatures, provided that the action described above is not thereby compromised.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A resin tube comprising a connecting section and a corrugated section formed alternate parts of peaks and valleys,
wherein the corrugated section has a straight portion at the valley along a longitudinal direction of the corrugated tube, and
the corrugated section is configured to have a rate Wb/Wa that is expressed by 1.2 to 2.0, where Wa denotes a longitudinal breadth of the peak on a base line, and Wb denotes a longitudinal breadth of the valley on the base line, the base line being defined as a line passing a position midway in an outside diameter direction between the peak and valley and drawn along the longitudinal direction.

2. The resin tube in accordance with claim 1, wherein, the corrugated tube is used to supply fuel pumped up from a fuel tank into a fuel injection valve of an engine.

3. The resin tube in accordance with claim 2, wherein the corrugated tube is made of a fuel-resistant resin material.

4. The resin tube in accordance with claim 3, wherein the resin material of the corrugated tube is selected from the group including polyamide, fluorine, polyester, polyketone, and polysulfide resins, thermoplastic elastomers, and ethylene-vinyl alcohol copolymers.

5. The resin tube in accordance with claim 1, wherein the corrugated section is formed to substantially same thickness.

6. The resin tube in accordance with claim 1, wherein the rate Wb/Wa is 1.3 to 1.5.
